(19) United States
(12) Patent Application Publication
(10) Pub. No.: US 2024/0002172 A1
(43) Pub. Date: Jan. 4, 2024

(54) PALLETIZER HAVING A PUSHER AND LANCES

(71) Applicant: DÜCKER GROUP GMBH, Langenfeld (DE)

(72) Inventor: Peter DUECKER, Langenfeld (DE)

(21) Appl. No.: 18/032,619

(22) PCT Filed: Nov. 9, 2021
(86) PCT No.: PCT/EP2021/081140

§ 371 Date: Apr. 19, 2023

(30) Foreign Application Priority Data
Nov. 10, 2020 (DE) 10 2020 129 646.0

(51) Int. Cl. B65G 57/24; B65G 57/06; B65G 47/82

(52) U.S. Cl. CPC B65G 57/24; B65G 57/06; B65G 47/82

(57) ABSTRACT

The invention relates to a method for transferring a conveyed item (2) from a first conveying device (3) onto a base (5) of an additional conveying device (4), by means of an apparatus (1) having a first conveying device (3) and an additional conveying device (4), by means of which apparatus a conveyed item (2) is moved onto a base (5), characterized in that, by means of a lance device (7) having a plurality of lances, the conveyed item (2) is transferred from the first conveying device (3) onto the base (5), which lies on the second conveying device (4).

The invention relates to an apparatus and a method for transferring material from a first conveyor to a support on a second conveyor, the apparatus having the first conveyor and the second conveyor that move material onto a support, according to the features of the preambles of the two independent patent claims.

Frequently, conveyed goods are moved by fork-lift trucks or comparable equipment. However, these movement sequences cannot be automated in order to increase production speed. In addition, an apparatus and a method for transferring material from a first conveyor to a support of a second conveyor are already known, having an apparatus having a first conveyor and a second conveyor that move the conveyed material to a support in order to automate the movements. However, these are not optimal with regard to the working speed and also with regard to wear.

The object of the invention is therefore to provide an apparatus and a method for transferring material from a first conveyor to a support on a second conveyor which is improved with regard to the working speed and also with regard to wear.

This object is achieved by the features of the two independent patent claims.

The presence and operation of a lance assembly having a plurality of lances, which convey and thus transfer the convened material, has the advantage that the surface on which the material to be conveyed rests is significantly smaller than a continuous (flat) support and thus friction is reduced. In this way, less energy is expended for the movement process and the working speed can be increased. In addition, the material to be conveyed is protected during the movement, so that the wear of the lances and/or of the material to be conveyed is reduced.

In the following the individual parts of the apparatus (also referred to without limiting as a palletizer) as well as the sequence of the associated method are explained with reference to the figures.

Palletizing Station Function Sequence:

1. Incoming Stack on Stack Slide and Pallet on Empty Pallet Pusher:

The apparatus 1 according to the invention is designed to transfer material 2, in particular a stack, from a first conveyor 3 to a further downstream conveyor 4. It further comprises a support 5 (for example a pallet), a pusher 6, a lance assembly 7 and a pusher slide 8 having respective drives not shown in detail.

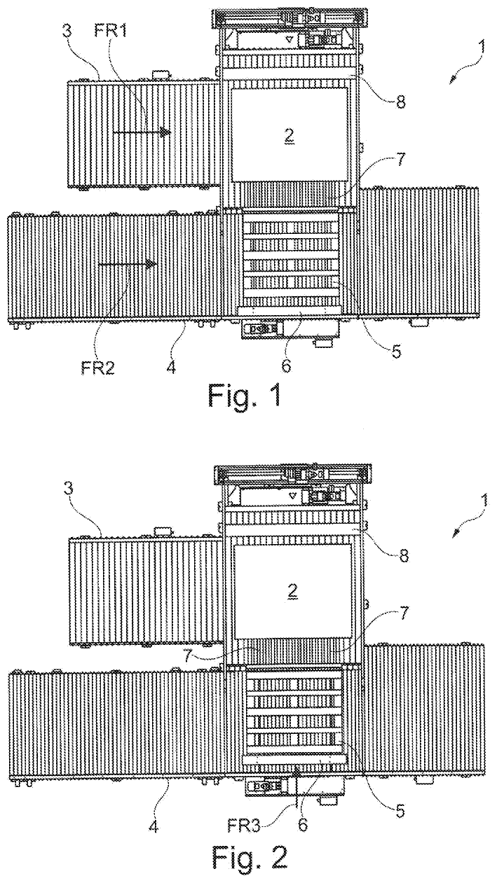

In the step of FIG. 1, the first conveyor 2, for example a roller conveyor, conveys the material 2 and aligns it in a position for transfer to a second conveyor 4, for example also a roller conveyor. The second conveyor 4 carries a support 5, shown here for example as a Euro pallet, is already in its intended position. The material 2 was moved into its respective intended position in a longitudinal travel direction FR1 and the support 5 in a parallel direction FR2.

2. The pallet pusher shifts the pallet against the stop and fixes it there:

In this step in FIG. 2, the support 5 (in particular a Euro pallet) is moved by the pusher 6 (an empty-pallet pusher) of the second conveyor 4 in a transverse travel direction FR3 to the transfer point from the first conveyor 1 and is fixed there. This causes the Euro pallet to no longer move out of its assumed position during the subsequent transfer of the material 2.

The lance assembly 7 is still in its starting position in the first conveyor 3.

3. Extending the lances of the lance assembly (of the lance truck):

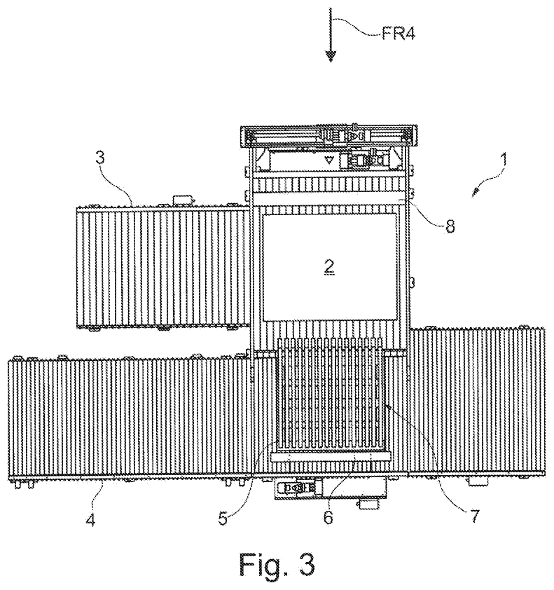

FIG. 3 shows that the lance assembly 7 has been moved into the station of the second conveyor 4 specifically such that the lances of the lance assembly 7 mesh approximately congruently with the support 5. In other words, in the first conveyor 2, in the station of the transfer station of the material 2, a plurality of tines (also referred to as lances) are oriented parallel to one another in respective recesses (grooves) in the transfer station of the conveyed goods 2 recessed in the first conveyor 3, so that the conveyed goods 2 can be pushed into this transfer station without these lances interfering. This reduces friction and increases production speed. For subsequent movement of the material 2 from the first conveyor 3 to the second conveyor 4, the assembly of lances 7 oriented parallel to one another is raised and moved toward the support 5, in particular the Euro pallet fixed there, more precisely into alignment over the surface thereof. Fixing in position is absolutely necessary in order to prevent the support 5 from leaving its intended position while the material 2 is transferred to it by the lance assembly 7. This transfer takes place in the transverse travel direction FR4. The lances of the lance assembly are in contact with their upper region (in the case of tubular lances, for example the upper vertex thereof) facing the conveyed goods 2, somewhat above the plane on which the conveyed goods 2 rests, so that the lance assembly 7 can move the conveyed material in the travel direction FR4 from the first conveyor 3.

A second conveyor 4 can be transferred. As an alternative to this, it is possible to lower the lances below the upper plane on which the conveyed goods 2 are moved on the first conveyor 3, until the conveyed goods 2 has assumed its position shown in FIG. 3. Thereafter, the lances can be raised somewhat so that the underside of the material 2 lifts off the surface of the first conveyor 3, so that the material 2 is transferred only on the lance assembly 7 to the second conveyor 4.

4. The stack pusher shifts the stack onto the lances above the pallet:

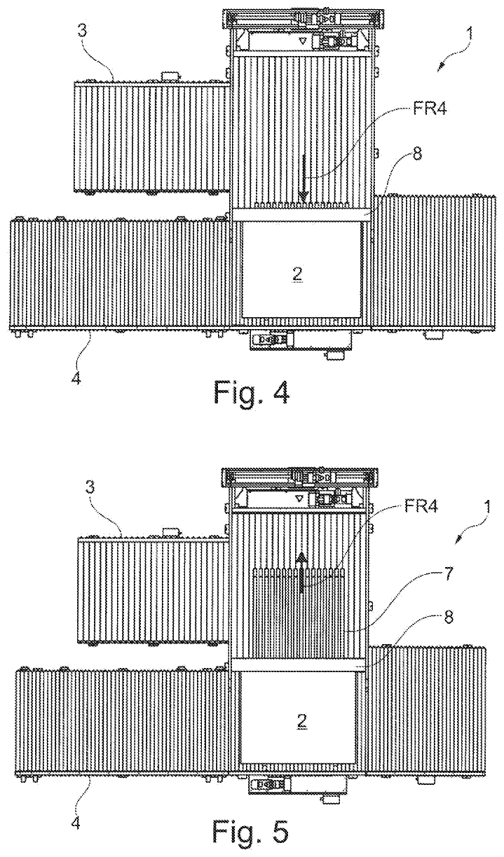

After the tines (lances of the lance assembly 7) have previously been moved into their intended transfer position (that is to say when their end comes to rest on the pusher 6 (the empty pallet pusher) or has been brought into the vicinity thereof), according to the illustration in FIG. 4, the lances of the assembly 7 move the material 2 into position above the support 5 (in particular the Euro pallet) by the slider 8 (the stacking slide), i.e. that the underside of the material 2 slides over the surface of the lances, which can be realized very well by the parallel oriented lances with minimal friction and with only a low expenditure of force.

5. The lance assembly is retracted and the stack is deposited on the pallet:

After the material 2 has arrived in its intended position above the support 5 (in particular the Euro pallet) as shown in FIG. 5, the lances, which are preferably combined to form a so-called lance comb and can thus be driven simultaneously, are moved back into their starting position in the transfer station of the first conveyor 3 counter to the travel direction FR4. This causes the underside of the material 2 to be deposited on the upper side of the Euro pallet after the lances have been moved out.

6. Both the stack slide and the empty pallet pusher return to their starting positions:

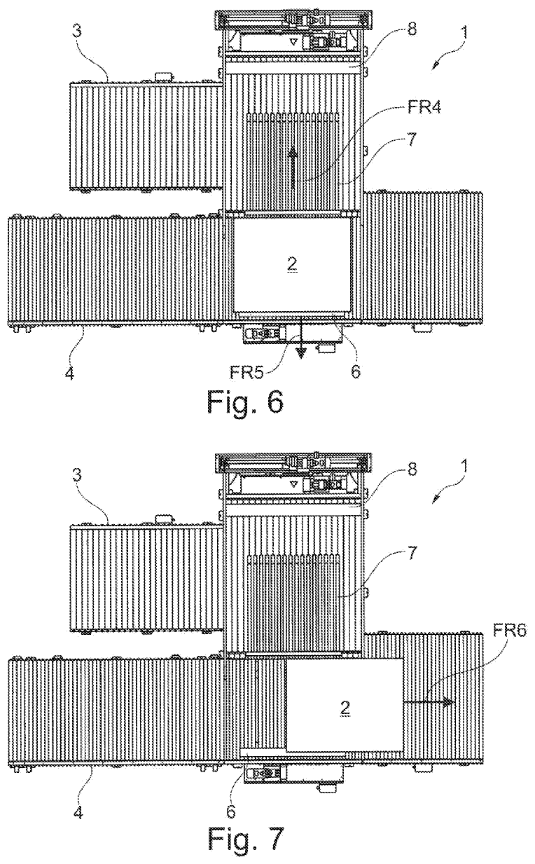

After the material 2 has been deposited on the support 5 (in particular the Euro pallet), according to the illustration in FIG. 6, both the pusher 8 (the stack pusher or stack slide) moves counter to the travel direction FR4 and the pusher 6 (the empty pallet pusher) returns to its starting position in the travel direction FR5, as a result of which the support 5 (in particular the Euro pallet) carrying the conveyed goods 2 deposited on it is passed to the second conveyor 4 and moved again and together with the conveyed goods 2 into a further position on the second conveyor 4 in accordance with the view of FIG. 7.

7. The palletized stack (several cardboard panels deposited on top of one another on the Euro pallet) is conveyed out:

FIG. 7 thus shows that the support 5 (in particular the Euro pallet) with the conveyed goods 2 now deposited on it is released on the second conveyor 4 and can thus be moved again and, in accordance with the view of FIG. 7, it can be moved together with the conveyed goods 2 into a further position on the second conveyor 4.

In order to keep the cycle time as low as possible, it is possible/necessary for some of the functions or method steps set out above to be carried out overlapping or simultaneously.

Options:

The empty pallet pusher is prepared for pneumatic stroke with bellows cylinders and two positions (top, bottom), in the event that it is necessary to lift the stack before moving out in order to prevent it from being able to hang on the stack slide.

China pallets longitudinally and transversely
min pallet L1000×B600
max pallet L1600×B1200
Pallet height 150 mm
Pallet max 300 mm. Unpacked
Cycle 30 seconds
   (The above statements are purely exemplary and not restrictive)

### LIST OF REFERENCE SIGNS

1. apparatus
2. Material to be conveyed
3. First conveyor
4. Second conveyor
5. Backing
6. Pusher (also referred to as empty-pallet pusher)
7. Lance assembly
8. Slide (also referred to as a stack slide)

1. An apparatus comprising:
a first conveyor; and
a second conveyor that together with the first conveyor move material onto a support; and
a lance assembly having a plurality of lances for transferring the material from the first conveyor to the support that rests on the second conveyor.

2. The apparatus according to claim 1, wherein the lance assembly has a plurality of parallel lances movable together.

3. The apparatus according to claim 1, further comprising:
a pusher that arrests the support in its position at least during transfer of the material from the first conveyor to the second conveyor.

4. The apparatus according to claim 1, further comprising: characterized
a pusher that moves the material from the first conveyor to the second conveyor.

5. The method according to claim 7, wherein the conveyed goods is a stack of wood or cardboard panels lying one on top of the other.

6. The apparatus according to claim 1, wherein the support is a pallet.

7. A method of transferring material from a first conveyor of a second conveyor with an apparatus comprising a first conveyor and a second conveyor that move material onto a support, the method comprising the step of using a lance assembly having a plurality of lances to transfer the material from the first conveyor that rests on the second conveyor.

8. The method according to claim 7, further comprising the step that
a retainer retains the support in its position at least during transfer of the material from the first conveyor to the second conveyor.

9. The method according to claim 7, wherein a pusher moves the material from the first conveyor to the second conveyor.
